(19) United States
(12) Patent Application Publication
(10) Pub. No.: US 2008/0099022 A1
(43) Pub. Date: May 1, 2008

(54) Respirator That Uses A Predefined Nose Foam Shape

(75) Inventors: Yonas Gebrewold, Roseville, MN (US); Thomas J. Xue, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/553,082

(22) Filed: Oct. 26, 2006

(51) Int. Cl. A62B 18/02; A62B 18/08

(52) U.S. Cl. 128/206.21; 128/206.24

(57) ABSTRACT

A respirator 10 that comprises a mask body 32 and a nose foam 10. The mask body 32 is adapted to fit over the nose and mouth of a person and has an interior surface 34. The nose foam 10 has a rear side 24, a front side 26, a rear side 24, and is secured to the interior surface 34 of the mask body 32 at a mask contacting surface 12. The nose foam 10 also has a central portion 14 and first and second side-contacting portions 16 and 18 that are symmetrically located on opposing sides of the central portion. The nose foam further has a nose-contacting surface 20 that extends over the central portion 14 and the first and second side-containing portions 16, 18. The nose-contacting surface 20 is skewed at first and second angles α to a plane 22 that cuts through the nose foam orthogonally to its lengthwise dimension. A nose foam of this construction can provide a snug fit to a wearer's face in the nose region without having to use a nose clip.

The present disclosure pertains to a respiratory mask that has a nose foam that has a particular preconfigured shape for assisting in providing a snug fit over the wearer's nose when the mask is being worn.

### BACKGROUND

Respirators (sometimes referred to as “filtering face masks” or “filtering face pieces”) are generally worn over the breathing passages of a person for two common purposes: (1) to prevent impurities or contaminants from entering the wearer's respiratory system; and (2) to protect other persons or things from being exposed to pathogens and other contaminants exhaled by the wearer. In the first situation, the respirator is worn in an environment where the air contains particles that are harmful to the wearer, for example, in an auto body shop. In the second situation, the respirator is worn in an environment where there is risk of contamination to other persons or things, for example, in an operating room or clean room.

To meet either of these purposes, the mask body of the respirator must be able to maintain a snug fit to the wearer's face. Known mask bodies can, for the most part, match the contour of a person's face over the cheeks and chin. In the nose region, however, there is a complex change in contour, which makes a snug fit more difficult to achieve. The failure to obtain a snug fit can be problematic in that air can enter or exit the respirator interior without passing through the filter media. When this happens, contaminants may enter the wearer's breathing track, or other persons or things may become exposed to contaminants exhaled by the wearer. In addition, a wearer's eyeglasses can become fogged when the exhalate escapes from the respirator interior over the nose region. Fogged eyewear, of course, makes visibility more troublesome to the wearer and creates unsafe conditions for the wearer and others.

Nose foams have been used on respirators to assist in achieving a snug fit over the wearer's nose. Nose foams also are used to improve wearer comfort. Conventional nose foams are typically in the form of compressible strips of foam—see, for example, U.S. Pat. Nos. 6,923,182, 5,765,556, and U.S. Published Application 2005/0211251. Known nose foams have been designed to be wider on each side of a central portion—see, for example, U.S. Pat. Nos. 3,974,829 and 4,037,593. Nose foams also have been used in conjunction with a conformable nose clip to obtain the snug fit—see, for example, U.S. Pat. Nos. 5,558,089, 5,307,796, 4,600,002, 3,603,315, and Des. 412,573 and British Patent GB 2,103,491.

Although known nose foams are able to help provide a snug fit over the wearer's nose, the nose foams generally are not fashioned to particularly address the contour of the various surfaces on a person's nose. Known nose foams are often cut into a three-dimensional, linearly-shaped geometry. Because a person's nose exhibits a radical curvature relative to the other parts of a person's face, known nose foams are often designed to be sufficiently thick or to be easily compressible to achieve a good seal when disposed over a wearer's nose. Known nose foams are also frequently used in conjunction with a nose clip to achieve the snug fit.

### SUMMARY OF THE INVENTION

The present invention provides a respirator that comprises: (a) a mask body that is adapted to fit over the nose and mouth of a person and that has an interior surface; and (b) a nose foam that comprises: (i) a front side, a rear side, and a mask contacting surface, the nose foam being secured to the interior surface of the mask body at the mask contacting surface; (ii) a central portion; (iii) first and second side-contacting portions that are symmetrically located on opposing sides of the central portion; and (iv) a nose-contacting surface that extends over the central portion and the first and second side-containing portions, the nose-contacting surface being skewed at first and second angles α to a plane that cuts through the nose foam orthogonally to a lengthwise dimension. Preferably, the first and second angles α open in a direction extending from the rear side of the nose foam to the front side thereof.

The present invention differs from known respirators in that the nose foam has a nose-contacting surface that is skewed at first and second angles α to a plane that extends normal to the nose foam. Applicants discovered that if the nose foam is provided with such angles that the nose foam can be adapted to better accommodate a person's nose and thereby provide a good fit on this area of the face. By pre-shaping the nose foam in this manner, there is less need for deformation of the foam to achieve a snug fit over the wearer's nose. There also may be less opportunity for a leak to occur in the nose region of the mask body. And a snug fit may be able to be achieved without use of a nose clip.

These and other advantages of the invention are more fully shown and described in the drawings and detailed description of this invention, where like reference numerals are used to represent similar parts. It is to be understood, however, that the drawings and description are for illustration purposes only and should not be read in a manner that would unduly limit the scope of this invention.

### GLOSSARY

The terms set forth below will have the meanings as defined:

“aerosol” means a gas that contains suspended particles in solid and/or liquid form;

“central portion” is the central part of the nose foam that extends over the bridge or top of a wearer's nose;

“clean air” means a volume of atmospheric ambient air that has been filtered to remove contaminants;

“comprises (or comprising)” means its definition as is standard in patent terminology, being an open-ended term that is generally synonymous with “includes”, “having”, or “containing”. Although “comprises”, “includes”, “having”, and “containing” and variations thereof are commonly-used, open-ended terms, this invention also may be described using narrower terms such as “consists essentially of”, which is semi open-ended term in that it excludes only those things or elements that would have a deleterious effect on the performance of the nose foam in serving its intended function;

“contaminants” means particles (including dusts, mists, and fumes) and/or other substances that generally may not be considered to be particles (e.g., organic vapors, et cetera) but which may be suspended in air, including air in an exhale flow stream;

“compressible” means that the nose foam can exhibit a noticeable reduction in volume in response to a pressure or force placed thereupon when the mask body is worn on a person's face;

“crosswise dimension” is the dimension that extends across a wearer's nose when the respirator is worn; it is synonymous with the “lengthwise” dimension of the nose foam;

“exhalation valve” means a valve that has been designed for use on a respirator to open unidirectionally in response to pressure or force from exhaled air;

“exhaled air” is air that is exhaled by a respirator wearer;

“exterior gas space” means the ambient atmospheric gas space into which exhaled gas enters after passing through and beyond the mask body and/or exhalation valve;

“exterior surface” means that the surface that is located on the exterior;

“filter media” means an air-permeable structure that is designed to remove contaminants from air that passes through it;

“front side” means the side of the nose foam that is located towards the front of the mask body when the nose foam is secured thereto;

“harness” means a structure or combination of parts that assists in supporting the mask body on a wearer's face;

“interior gas space” means the space between a mask body and a person's face;

“interior surface” means the surface that is located on the inside;

“lengthwise dimension” means the direction of the length (long axis) of the nose foam (which extends across the bridge of the wearer's nose when the mask is worn);

“malleable” means deformable in response to mere finger pressure;

“mask body” means an air-permeable structure that can fit at least over the nose and mouth of a person and that helps define an interior gas space separated from an exterior gas space;

“mask contacting” means a surface of nose foam that has sufficient surface area to enable adequate securement of the nose foam to the interior surface of the mask body;

“memory” means that the deformed part has a tendency to return to its preexisting shape after deforming forces have ceased;

“non-integral”, in reference to the nose foam, means made separately from;

“nose clip” means a mechanical device (other than a nose foam), which device is adapted for use on a mask body to improve the seal at least around a wearer's nose;

“nose contacting surface” means a surface of the nose foam that is sized to be sufficiently large and is appropriately positioned to enable the nose foam to make adequate contact with a wearer's nose when the respirator is being worn;

“nose foam” means a porous material that is adapted for placement on the interior of a mask body to improve fit and/or wearer comfort over the nose when the respirator is worn;

“nose region” means the portion of the mask body that resides over a person's nose when the respirator is worn;

“orthogonally” means at right angles;

“particles” means any liquid and/or solid substance that is capable of being suspended in air, for example, dusts, mists, fumes, pathogens, bacteria, viruses, mucous, saliva, blood, etc.;

“polymer” means a material that contains repeating chemical units, regularly or irregularly arranged;

“polymeric” and “plastic” each mean a material that mainly includes one or more polymers and may contain other ingredients as well;

“porous” means a mixture of a volume of solid material and a volume of voids;

“portion” means part of a larger thing;

“predefined” means a result of its intended configuration upon manufacture and not a result of a later deformation from, for example, use or placement on a mask body;

“rear side” means the side of the nose foam that is located towards the rear of the mask body when the nose foam is secured thereto (the rear side would be located closer to the wearer's face than the front side when the respirator is being worn);

“respirator” means a device that is worn by a person to filter air before the air enters the person's respiratory system;

“side-contacting portion” means a portion of the nose foam that would make contact with the side of a person's nose when the respirator is worn;

“skewed” means not parallel;

“snug fit” or “fit snugly” means that an essentially air-tight (or substantially leak-free) fit is provided (between the mask body and the wearer's face);

“thermoplastic” means a polymer or polymeric material that may be softened by heat and hardened by cooling in a reversible physical process; and

“transverse dimension” means the dimension that extends at a right angle to the lengthwise dimension.

### BRIEF DESCRIPTION OF THE DRAWINGS

FIG. 1 is a perspective rear view of a nose foam 10 in accordance with the present invention;

FIG. 2 is a rear view of the nose foam 10 of FIG. 1;

FIG. 3 is a right side view of the nose foam 10;

FIG. 4 is a bottom view of nose foam 10;

FIG. 5 is a rear view of a respirator 30 that includes a nose foam 10 in accordance with the present invention; and

FIG. 6 is a cross-section of a multi-layered mask body 32 that can be used in a respirator 30 of the present invention.

### DETAILED DESCRIPTION

In describing preferred embodiments of the invention, specific terminology is used for clarity sake. The invention, however, is not intended to be limited to the specific terms so selected, and each term so selected includes all technical equivalents that operate similarly.

In practicing the present invention, a new respirator is provided that has a nose foam of predefined configuration to improve fit in the nose region of a person's face. The nose foam may be configured such that the nose contacting surface is skewed at first and second angles α to a plane that cuts through the nose foam orthogonally thereto. In reference to “cuts through the nose foam orthogonally thereto”, this phrase refers to an imaginary plane that passes through the nose foam at right angles to the lengthwise dimension from the rear side of the nose foam to its front side thereof. When the nose foam is cut or otherwise fashioned into such a predefined shape, the foam may have less need to exhibit compaction or deformation in one or more locations along the length of the nose foam when it is worn by a person. There also may be less need to supply the mask with a deformable nose clip for accommodating the mask to the shape of the wearer's nose.

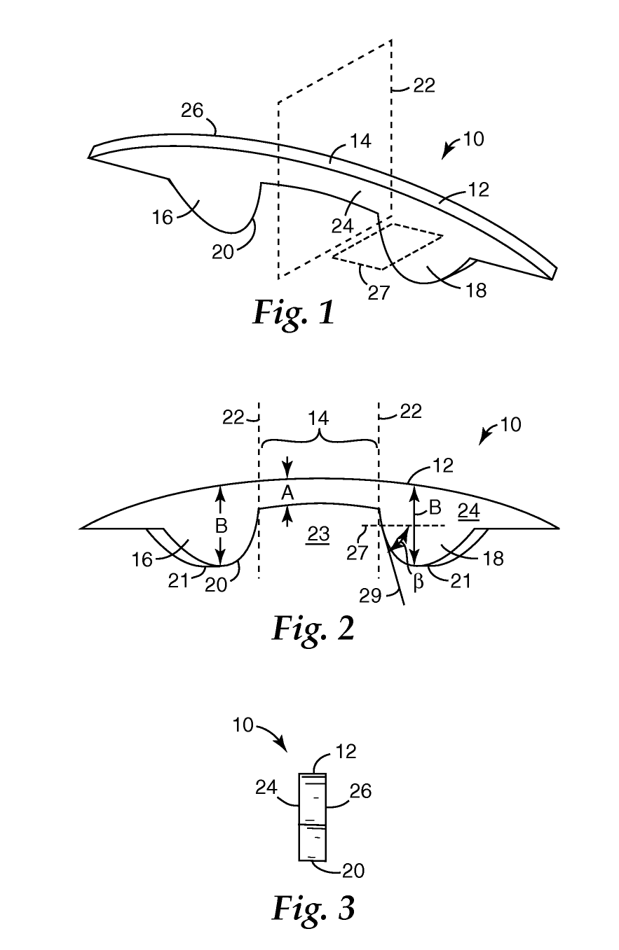

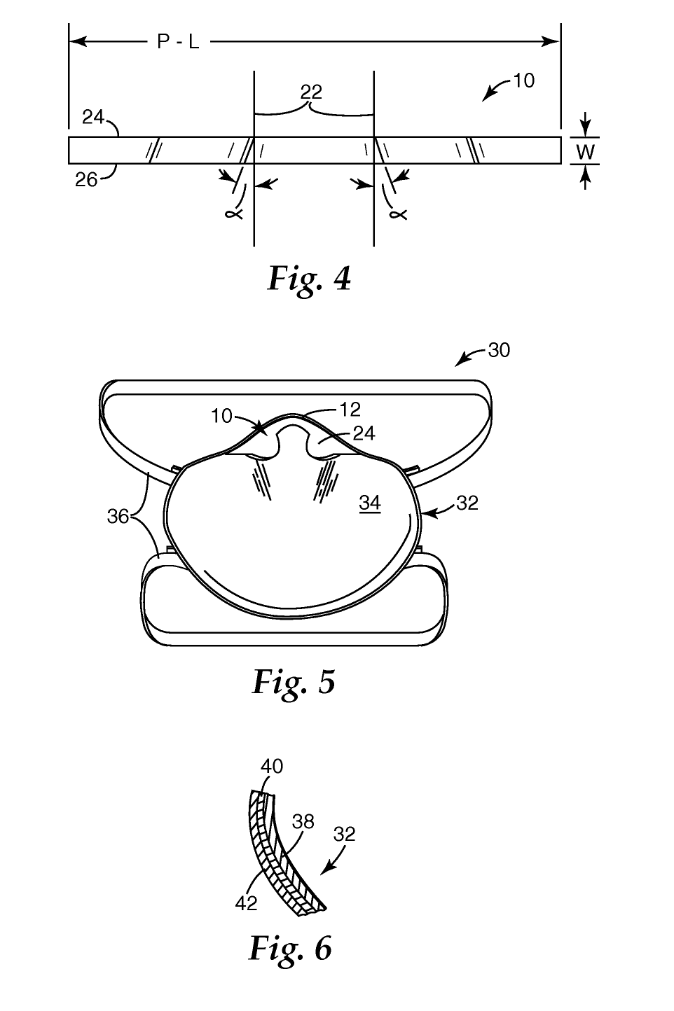

FIGS. 1-4 illustrate an embodiment of a nose foam 10 that may be used in conjunction with the present invention. The nose foam 10 has a mask-contacting surface 12, a central portion 14, first and second side-contacting portions 16 and 18 and a nose-contacting surface 20. The mask-contacting surface 12 makes contact with the interior surface 34 of a mask body 32 (FIG. 5) when the nose foam 10 is secured thereto. The central portion 14 has a thickness A, and the first and second side-contacting portions have a thickness B. The first and second side-contacting portions 16, 18 are symmetrically located on opposing sides of the central portion 14. As illustrated, the thickness B is greater than the thickness A. Thickness A is typically about 0.2 to about 1.5 cm, more typically about 0.4 to 0.8 cm, and thickness B is about 0.4 to about 2.5 cm, more typically 1.2 to 2 cm. As used in this document, the term “thickness” refers to the maximum thickness in the particular portion that is being measured. The nose-contacting surface 20 extends over the central portion 14 and the first and second side-contacting portions 16 and 18. As the nose contacting surface 20 proceeds from the central portion 14 to the peak 21 on each side contacting portion 16, 18, the surface 20 is spaced from itself by a greater distance—that is, the open space 23 increases or the nose foam gets wider in the direction moving away from the mask contacting surface 12. The nose-contacting surface 20 is skewed at first and second angles α to a plane 22 that cuts through the nose foam 10 orthogonally thereto. In FIG. 1, the plane 22 is shown cutting through the nose foam 10 centrally; whereas in FIGS. 2 and 4, the plane is illustrated cutting through the nose foam 10 at locations where the central portion meets the first and second side portions 16 and 18. Each angle α may be the same or different from the other angle α. Angle α may be about 1 to about 65 degrees, more typically about 5 to about 40 degrees, still more typically about 7 to about 15 degrees.

As shown in FIG. 2, the nose-contacting surface 20 preferably also has a further curved or angled surface on the first and second side contacting portions 16 and 18. The curved or angular relationship of the surface 20 on the first and second side-contacting portions 16 and 18 may be defined in relation to a plane 27 that passes through the nose foam 10 orthogonally thereto but parallel to its lengthwise dimension. As shown in FIGS. 1 and 2, the plane 27 bisects the nose foam 10 in that it passes midway between the mask-contacting surface 12 and the peak of the nose foam 21. To define the angle β, a line is drawn tangent to the curvature of the nose foam where plane 27 bisects the mask-contacting surface 20. Angle β is the same on both sides of the nose foam 10 and may be about 35 to 85 degrees, more typically is about 45 to 75 degrees, and still more typically is about 50 to 60 degrees.

As best shown in FIG. 4, the first and second angles α preferably open in a direction that extends from a rear side 24 of the nose foam 10 to a front side 26. FIG. 4 also shows that the nose foam 10 has a total projected lengthwise dimension P-L and a width W. The projected lengthwise dimension P-L is generally about 3 to 15 centimeters (cm), more commonly about 6 to 12 cm. The width W generally is about 0.6 to 1.4 cm, more typically about 0.8 to 1.2 cm. The width W is the distance between the first and second side surfaces 24 and 26, respectively, of the nose foam 10. As illustrated, the first and second side surfaces may be linear in configuration. The present invention nonetheless contemplates other non-linear or curved configurations for such surfaces. If the side surface(s) are not linear, the dimension W would be measured from its widest point. The central portion 14 has a projected length of about 1.2 to 3.2 cm, more commonly of about 2 to 2.8 cm. Although the central portion 14 and the first and second side contacting portions meet at a definitive line as shown in the drawings, the change from the central portion may be more subtle and could be represented by a smooth curve. The side contacting portions are preferably symmetrically bulbous in shape relative to the central portion. The term “bulbous” means that the first and second side contacting portions occupy an extended volume relative to the central portion such that the side contacting portions project out from the body of the nose foam as rounded or swollen members when viewed from the front and rear. Although the nose foam 10 is illustrated as having planar sides 24 and 26, these sides too may be rounded if desired. There also does not have to be a sharp (for example, 90°) transition from the side surface to the nose contacting surfaces. This transition also can be smooth or rounded.

The nose foam can be made from a variety of materials such a polyurethane, polyvinylchloride, polyolefin such as polypropylene and polyethylene, polyethylene vinyl acetate, rubber (natural or synthetic) such as polyisoprene, or combinations thereof. The nose foam may be made from an open cell or closed cell foam. Microcellular foams also may be used. The nose foam generally is porous and can have a smooth skin surface. The nose foam may be made from a compressible material (now known or later developed) that adapts to the shape of a person's nose. The nose foam can be made from a material that will noticeably compress in response to pressure exerted from the mask body against the face in response to a force created by the harness system. Such nose foam materials generally exhibit compression from mere finger pressure.

FIG. 5 shows the interior of a respirator mask 30 that includes a mask body 32 and the nose foam 10 secured to the interior surface 34 of the mask. When viewing the mask in an upright position as shown in FIG. 5, the nose foam 10 exhibits a concave downward curvature. The nose foam 10 can be secured to the mask body 32 by applying an adhesive to the mask-contacting surface 12 of the nose foam 10 or to the interior 34 of the mask body 32 or both. The adhesive could be, for example, a pressure-sensitive or hot-melt adhesive and could be applied as a coating or by spraying. Essentially any adhesive or other suitable means of securement, ultrasonic welding, for example, could be used to fasten the foam 10 to the mask body interior 34. See, for example, U.S. Pat. No. 6,125,849 to Williams et al. for a method of securing components to mask bodies using an adhesive. Mask body 32 is adapted to fit over the nose and mouth of a person in a spaced relation to a wearer's face to create an interior gas space or void between the wearer's face and the interior surface 34 of the mask body 32. The mask body 32 may be of a curved, hemispherical, cup-shape such as shown in FIG. 5 —see also U.S. Pat. No. 4,536,440 to Berg, U.S. Pat. No. 4,807,619 to Dyrud et al., and U.S. Pat. No. 5,307,796 to Kronzer et al. The respirator body also may take on other shapes as so desired. For example, the mask body can be a cup-shaped mask having a “chipmunk” type construction as shown in U.S. Pat. No. 4,827,924 to Japuntich. The mask body also may be a flat-folded product like the bi-fold and tri-fold mask products disclosed in U.S. Pat. Nos. 6,722,366 and 6,715,489 to Bostock, D459,471 and D458,364 to Curran et al., and D448,472 and D443,927 to Chen. See also U.S. Pat. Nos. 4,419,993, 4,419,994, 4,300,549, 4,802,473, and Re. 28,102. Because the nose foam of the invention has a shape that does not require as much compression of the foam to obtain a snug fit, the inventive respirator may not need a nose clip to ensure that such a fit is achieved. Nonetheless, the respirator 30 may include a nose clip (not shown) that can be conformed to the shape of the wearer's nose. If used, the nose clip may be made from a metal or plastic material that retains its deformed shape after being manually conformed. Examples of nose clips are shown in U.S. Pat. Nos. 5,558,089 and D412,573 to Castiglione, and in U.S. patent application Ser. No. 11/236,283 to Kalatoor et al. and Ser. No. 11/211,962 to Xue et al. Because the mask body shape at the nose region tends to be dictated by the shape of the nose clip, the nose foam curvature on the mask contacting surface 12 may be provided to generally match the curvature of the nose clip. The mask body may include one or more layers of filter media.

As shown in FIG. 5, the respirator 30 also includes a harness such as straps 36 that are sized to pass behind the wearer's head to assist in providing a snug fit to the wearer's face. The straps 36 preferably are made of an elastic material that causes the mask body 32 to exert a slight pressure on the wearer's face. A number of different materials may be suitable for use as straps 36, for example, the straps may be formed from a thermoplastic elastomer that is ultrasonically welded to the respirator body 36. Ultrasonic welding may be beneficial over the use of staples to fasten the harness to the mask body because use of metal is avoided. The 3M 8210™ particulate respirator is an example of a filtering face mask that employs ultrasonically welded straps. Woven cotton elastic bands, rubber cords (e.g. polyisoprene rubber) and/or strands also may be used, as well as non-elastic adjustable straps—see U.S. Pat. No. 6,705,317 to Castiglione and U.S. Pat. No. 6,332,465 to Xue et al. Other examples of mask harnesses that may be used in connection with the present invention are shown in U.S. Pat. Nos. 6,457,473B1, 6,062,221, and 5,394,568, to Brostrom et al., U.S. Pat. Nos. 6,591,837, 6,119,692 and 5,464,010 to Byram, and U.S. Pat. Nos. 6,095,143 and 5,819,731 to Dyrud et al. Essentially any strap system (presently known or later-developed) that is fashioned for use in supporting a respiratory face piece on a wearer's head could be used as a harness in connection with the present invention. The harness also could include a head cradle in conjunction with one or more straps for supporting the mask. The mask body may be spaced from the wearer's face, or it may reside flush or in close proximity to it. In either instance, the mask body helps define an interior gas space into which exhaled air passes before leaving the mask interior through the exhalation valve. The mask body also could have a thermochromic fit-indicating seal at its periphery to allow the wearer to easily ascertain if a proper fit has been established—see U.S. Pat. No. 5,617,849 to Springett et al.

The respirator also can have an exhalation valve (not shown) located thereon such as the unidirectional fluid valve disclosed in U.S. Pat. No. 6,854,463 to Japuntich et al. Examples of other suitable valves are described in U.S. Pat. RE37,974 to Bowers et al., U.S. Pat. Nos 7,028,689 and 7,013,895 to Martin et al., and U.S. Pat. No. 6,883,518 to Mittelstadt et al. An exhalation valve allows exhaled air to escape from the interior gas space without having to pass through the filter media in the mask body 32. The exhalation valve can be secured to the mask body through use of an adhesive—see U.S. Pat. No. 6,125,849 to Williams et al.—or by mechanical clamping—see U.S. Pat. Nos. 7,069,931, 7,007,695, and 6,604,524 to Curran et al. The illustrated mask body 32 is air permeable and may be provided with an opening (not shown) that is located where an exhalation valve would be attached to the mask body 32 so that exhaled air can rapidly exit the interior gas space through the exhalation valve. The preferred location of the opening on the mask body 32 is directly in front of where the wearer's mouth would be when the mask is being worn. The placement of the opening, and hence the exhalation valve, at this location allows the valve to open more easily in response to the force or momentum from the exhale flow stream. For a mask body 32 of the type shown in FIG. 5, essentially the entire exposed surface of mask body 32 is air permeable to inhaled air.

FIG. 6 shows that the mask body 32 may comprise multiple layers, including an inner stiffening or shaping layer 38, a filtration layer 40, and an outer cover web 42. The inner stiffening or shaping layer 38 provides structure to the respirator body 32 and support for the filtration layer 40. The shaping layer 38 can be located on the inside and/or outside of the filtration layer 40 and can be made, for example, from a non-woven web of thermally-bondable fibers that have been molded into, for example, a cup-shaped configuration by, for example, the method taught in U.S. Pat. No. 5,307,796 to Kronzer et al. A shaping layer 38 also could be made from a molded plastic net—see U.S. Pat. No. 4,850,347 to Skov. Although the shaping layer is designed with the primary purpose of providing structure to the mask and providing support for a filtration layer, the shaping layer also, in some instances, may act as a filter, typically for capturing larger particles suspended in the exterior gas space, if disposed outside of the filter layer 40. Together the shaping and filtration layers may operate as an inhale filter element. When a wearer inhales, air is drawn through the mask body, and airborne particles become trapped in the interstices between the fibers, particularly between the fibers in the filter layer. In the embodiment shown in FIGS. 5 and 6, the filter layer 40 is “integral” with the mask body 32—that is, it forms part of the mask body and is not an item that subsequently becomes attached to (or removed from) the mask body like a filter cartridge.

Filtering materials that are commonplace on negative pressure half mask respirators—like the filtering face mask 30 shown in FIG. 5—often contain an entangled web of electrically charged microfibers, particularly meltblown microfibers (BMF). Microfibers typically have an average effective fiber diameter of about 20 to 25 micrometers (μm) or less, but commonly are about 1 to about 15 μm, and still more commonly are about 2 to 10 μm in diameter. Effective fiber diameter may be calculated as described in Davies, C. N., The Separation of Airborne Dust and Particles, Institution of Mechanical Engineers, London, Proceedings 1B. 1952. BMF webs can be formed as described in Wente, Van A., Superfine Thermoplastic Fibers in Industrial Engineering Chemistry, vol. 48, pages 1342 et seq. (1956) or in Report No. 4364 of the Naval Research Laboratories, published May 25, 1954, entitled Manufacture of Superfine Organic Fibers by Wente, Van A., Boone, C. D., and Fluharty, E. L. Meltblown fibrous webs can be uniformly prepared and may contain multiple layers, like the webs described in U.S. Pat. Nos. 6,492,286B1 and 6,139,308 to Berrigan et al. When in the form of a randomly entangled web, BMF webs can have sufficient integrity to be handled as a mat. Electric charge can be imparted to fibrous webs using various techniques described in, for example, U.S. Pat. Nos. 6,454,986B1 and 6,406,657B1 to Eitzman et al.; U.S. Pat. Nos. 6,375,886B1, 6,119,691 and 5,496,507 to Angadjivand et al., U.S. Pat. No. 4,215,682 to Kubik et al., and U.S. Pat. No. 4,592,815 to Nakao.

Examples of fibrous materials that may be used as filters in a mask body are disclosed in U.S. Pat. No. 5,706,804 to Baumann et al., U.S. Pat. No. 4,419,993 to Peterson, U.S. Reissue Pat. No. Re 28,102 to Mayhew, U.S. Pat. Nos. 5,472,481 and 5,411,576 to Jones et al., and U.S. Pat. No. 5,908,598 to Rousseau et al. The fibers may contain polymers such as polypropylene and/or poly-4-methyl-1-pentene (see U.S. Pat. No. 4,874,399 to Jones et al. and U.S. Pat. No. 6,057,256 to Dyrud et al.) and may also contain fluorine atoms and/or other additives to enhance filtration performance—see, U.S. Pat. Nos. 6,432,175B1, 6,409,806B1, 6,398,847B1, 6,397,458B1 to Jones et al. and U.S. Pat. Nos. 5,025,052 and 5,099,026 to Crater et al., and may also have low levels of extractable hydrocarbons to improve performance—see U.S. Pat. No. 6,213,122 to Rousseau et al. Fibrous webs also may be fabricated to have increased oily mist resistance as described in U.S. Pat. No. 4,874,399 to Reed et al., and in U.S. Pat. Nos. 6,238,466 and 6,068,799, both to Rousseau et al. The filtration layer optionally could be corrugated as described in U.S. Pat. Nos. 5,804,295 and 5,763,078 to Braun. The mask body also can include an outer cover web to protect the filtration layer. The cover web may be made from nonwoven webs of BMF as well, or alternatively from webs of spunbond fibers. An inner cover web also could be used to provide the mask with a soft comfortable fit to the wearer's face—see U.S. Pat. No. 6,041,782 to Angadjivand et al. The cover webs also may have filtering abilities, although typically not nearly as good as the filtering layer.

The following Examples have been selected merely to further illustrate features, advantages, and other details of the invention. It is to be expressly understood, however, that while the Examples serve this purpose, the particular ingredients and amounts used, as well as other conditions and details, are not to be construed in a manner that would unduly limit the scope of this invention.

### EXAMPLES

### Example 1

UCAR Latex 154S and HYPO 2002 (from Dow Chemical Company, Midland, Mich.) prepolymer were used as starting materials to cast a three-dimensional polyurethane nose foam. Forty grams (g) of HYPO 2002 and 60 g of UCAR were mixed in a disposable plastic container using a mechanical blade mixer and were poured into a mold that had three cavities. The cavities were dimensioned to provide a nose foam that had a projected length P-L of about 105 mm, a thickness A in the central portion of 6 mm, and a thickness B in the first and second side contacting portions of 15 mm. The width W of each of the cavities was about 15 mm. The mold was pre-sprayed with release agent (Endurance Mold Release A353 made by Stoner, Quarryville, Pa.) before the pre-polyurethane mixture was poured into it. After about 10 minutes, the partially cured polyurethane foam was removed from the mold and was put into an oven maintained at 60° C. overnight to achieve full curing. The material was allowed cool to room temperature, and then the foam was cut to remove the weeds. Three pieces of 3-D nose foams were obtained. Angles α and β were 35° and 56°, respectively. 3M 9917 double-coated nonwoven tape was applied on the top side (flat side) of the nose foam, and then the nose foam was applied onto a 3M 8511 respirator that had the aluminum nose clip removed. The nose foam was positioned at the inside of the respirator opposite to where the aluminum nose clip was located.

### Example 2

This Example was prepared as described above in Example 1, except the nose foam was secured to a standard 3M 8210 respirator with the original nose clip and nose foam removed.

### Example 3

Double layered Foamex foam (Foamex, E. Rutherford, N.J.) foam was used to cut a nose foam that had a projected length P-L of 97 mm, a central portion thickness A of 7 mm, a side-contacting portion thickness B of 15 mm, a width W of 15, an angle α of 7°, and an angle β of 48°. A 7.5 mm thick section of foam was laid together back-to-back with another section to create a thicker foam of 15 mm thickness. The foam was then carved into the shape having the dimensions indicated above using a surgical knife and scissors. The carved nose foam was then attached to an 8511 respirator by using a 3M 9917 Double-coated Nonwoven tape, with the aluminum nose clip removed.

This invention may be suitably practiced in the absence of any element not specifically disclosed herein.

All patents and patent applications cited above, including those in the Background section, are incorporated by reference into this document in total. To the extent there is a conflict or discrepancy between the disclosure in such incorporated document and the above specification, the above specification will control.

This invention may take on various modifications and alterations without departing from its spirit and scope. Accordingly, this invention is not to be limited to the above-described but is to be controlled by the limitations set forth in the following claims and any equivalents thereof.

What is claimed is:

1. A respirator that comprises:
(a) a mask body that is adapted to fit over the nose and mouth of a person and that has an interior surface; and
(b) a nose foam that comprises:
(i) a front side, a rear side, and a mask contacting surface, the nose foam being secured to the interior surface of the mask body at the mask contacting surface;
(ii) a central portion;
(iii) first and second side-contacting portions that are symmetrically located on opposing sides of the central portion; and
(iv) a nose-contacting surface that extends over the central portion and the first and second side-containing portions, the nose-contacting surface being skewed at first and second angles α to a plane that cuts through the nose foam orthogonally to a lengthwise dimension.

2. The respirator of claim 1, wherein the first and second angles α open in a direction extending from the rear side of the nose foam to the front side thereof.

3. The respirator of claim 1, wherein the central portion has a thickness A and the first and second side contacting portions have a thickness B, and wherein thickness B is greater than the thickness A.

4. The respirator of claim 3, wherein the thickness A is about 0.4 to about 0.8 cm, and the thickness B is about 1.2 to about 2 cm.

5. The respirator of claim 1, wherein the nose contacting surface is skewed in first and second locations that are located, respectively, on the opposing first and second side-contacting portions.

6. The respirator of claim 1, wherein the nose foam is compressible and comprises polyurethane, polyvinylchloride, polypropylene, polyethylene, polyethylene vinyl acetate, rubber, or a combination thereof, and wherein the nose foam is an open cell or closed cell foam or is a microcellular foam.

7. The respirator of claim 1, wherein each angle α is about 1 to about 65 degrees.

8. The respirator of claim 1, wherein each angle α is about 5 to about 40 degrees.

9. The respirator of claim 1, wherein each angle α is about 7 to about 15 degrees.

10. The respirator of claim 2, wherein each angle α is about 1 to about 65 degrees.

11. The respirator of claim 1, wherein the nose-contacting surface is further defined by first and second angles β, which angles β are defined by a first line drawn tangent to the nose foam curvature at a point where a plane bisects the nose foam normally thereto, each angle β being about 35 to about 85 degrees.

12. The respirator of claim 11, wherein β is about 45 to about 75 degrees.

13. The respirator of claim 1, wherein the nose foam has a width W of about 0.8 cm to about 1.2 cm, and a projected length of about 2 to 2.8 cm.

14. The respirator of claim 1, wherein the mask body comprises a plurality of layers, wherein at least one of the layers is a fibrous filtration layer, and wherein the mask body has a harness secured thereto.

15. A method of making a respirator, which method comprises:
(a) providing a mask body that is adapted to fit over the nose and mouth of a person and that has an interior surface; and
(b) providing a nose foam that comprises:
(i) a front side, a rear side, and a mask contacting surface, the nose foam being secured to the interior surface of the mask body at the mask contacting surface;
(ii) a central portion;
(iii) first and second side-contacting portions that are symmetrically located on opposing sides of the central portion; and
(iv) a nose-contacting surface that extends over the central portion and the first and second side-containing portions, the nose-contacting surface being skewed at first and second angles α to a plane that cuts through the nose foam orthogonally to a lengthwise dimension; and
(c) securing the nose foam to the interior surface of the mask body.
